(19) United States
(12) Patent Application Publication
(10) Pub. No.: US 2003/0023500 A1
(43) Pub. Date: Jan. 30, 2003

(54) System and method for buying and selling merchandise

(75) Inventors: Stephen J. Boies, Mahopac, NY (US); Samuel H. Dinkin, Austin, TX (US); David P. Greene, Ossing, NY (US); William Grey, Millwood, NY (US); Paul Andrew Moskowitz, Yorktown Heights, NY (US); Philip Shi-Lung Yu, Chappaqua, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 09/916,679

(22) Filed: Jul. 30, 2001

(51) Int. Cl. G06F 17/60

(52) U.S. Cl. 705/26

(57) ABSTRACT

A system for buying and selling merchandise includes a network having a plurality of user terminals, a memory device for storing a predetermined event for the merchandise, and at least one processor, accessible by the plurality of user terminals, for automatically adjusting a price of the merchandise based on the predetermined event, and matching buyers with the merchandise to facilitate a transaction.

### BACKGROUND OF THE INVENTION

1. Field of the Invention

The present invention generally relates to a system and method for buying and selling merchandise, and in particular, a system and method for buying and selling merchandise in which the merchandise price is automatically adjusted.

2. Description of the Related Art

The advent of the internet has given rise to diverse and varied systems and methods for conducting business. Specifically, electronic commerce in which items are bought and sold over the world wide web has experienced rapid growth.

As shown in FIG. 1, a conventional electronic commerce system 100 may include multivariate negotiation system 150 for iterative bargaining which enables a sponsor to create and administer a community between participants such as buyers and sellers having similar interests, and allows a buyer to search and evaluate seller information, propose and negotiate orders and counteroffers that include all desired terms, request sample quantities, and track activity. The conventional negotiation system 150 also allows a seller to use remote authoring templates to create a complete Website for immediate integration and activation in the community, evaluate proposed buyer orders and counteroffers, and negotiate multiple variables such as price, terms, conditions, etc.

Specifically, the conventional negotiation system 150 communicates over a telecommunications link 110 to the internet 120. The system 150 includes the software needed to create communities, communicate with sponsors 130 and participants 140, and store the results. Participants in the community can, therefore, connect to the community sponsor through the internet 120 and the negotiation system 150, using only a standard internet browser and a conventional desktop computer to activate the browser over a link to the internet.

More specifically, as shown in FIG. 1, the website 175 of the negotiation system 150 has webserver hardware 155 containing standard webserver software, an IP firewall 165, server farm 160 and database server hardware 180 storing data 185. The webserver 155 enables communications in the transmission control protocol/internet protocol (TCP-IP) format, to be received from the internet 120. All the components of the negotiation system 150 are installed separate from any sponsor 130 or participant 140 sites.

The operation of the negotiation system 150 begins with the occurrence of an initializing event. For example, participant 140 may propose terms to another participant on an initiating terminal (or desktop computer or workstation, etc.) over the internet 120 through the conventional electronic commerce system 100, thereby creating a communications path which is ultimately directed by a multivariate negotiation system 150 over the internet 120 to the destination terminal at which the selected or other participant 140 is active. The terms could be, for example, the placement of an order from a buyer, or a seller's response to a general request for proposal (RFP).

However, the conventional electronic commerce system 100 does not conveniently automatically adjust a price of merchandise (e.g., over time or based upon the happening of a predetermined event). For example, the convention system 100 does not address commerce in time-sensitive merchandise (i.e., merchandise having a quality that is affected by time). Such merchandise may have an expiration date after which it should not be sold or should not be consumed. A bottle of aspirin, for example, may expire twenty-four months after it is manufactured. After this date it may lose its effectiveness. Indeed, some goods may even be dangerous to consumers after the expiration date. For example, certain foods may make a consumer ill if consumed after the expiration date.

Conventional systems, for example, are not designed to address the many variables associated with time-sensitive merchandise. As a result, buyers of time-sensitive merchandise typically pay the same price for the merchandise regardless of whether the merchandise expires 2 years or 2 months from an expiration date. On the other hand, because buyers are less likely to buy merchandise having a short expiration period, sellers (e.g., manufacturers, wholesalers and retailers) are often left with boxes of the merchandise which the sellers cannot sell. Indeed, even the most efficient, organized and diligent manufacturers, wholesalers and retailers cannot avoid wasting large quantities of time-sensitive merchandise which was not sold by an expiration date. Indeed, sellers often factor in the cost of such wasted goods into the price of the goods, resulting in higher prices to consumers.

One conventional approach to reducing wasted time-sensitive merchandise is to reduce the price of the goods as the expiration dates of the goods near. For example, a retail produce market may sell bananas for $1.00 a pound when the bananas are fresh and green and have just arrived at the market. But several days later when the bananas are beginning to turn brown and soft, the market may place the bananas “on sale” and reduce the price to $0.50 a pound. Of course, the reduced price is a real incentive to the consumer to purchase the bananas. However, only a person with a real appetite for bananas may be willing to buy a bunch of bananas knowing that the bananas will expire within two or three days. In other words, a consumer will consider his rate of consumption of bananas before buying the bananas so near the expiration date.

For example, if the consumer buys one pound of the brown bananas having one week until expiration, but only eats two bananas, the effective cost of the bananas is $0.25 per banana. On the other hand, if the consumer would have bought one pound of the green bananas having three weeks until expiration, and eats two bananas a week, the effective cost of the bananas is about $0.17 per banana. Thus, the sale would not save the consumer money and, therefore, the price reduction is not enough incentive for the consumer to purchase the brown bananas.

However, while such a system may be implemented, for example, at a corner market, such a manual system cannot be efficiently implemented on a large scale. Therefore, even in this high-tech age, conventional systems do not conveniently automatically adjust a merchandise price and so commerce (e.g., commerce involving time-sensitive merchandise) continues to be inefficient. One result of such inefficiency, for example, is that time-sensitive merchandise that could be bought and sold at reduced prices, instead expire on the shelves of manufacturers, wholesalers and retailers.

### SUMMARY OF THE INVENTION

In view of the foregoing, and other problems, disadvantages, and drawbacks of conventional methods, the present invention has been devised, and it is an object of the present invention to provide a system and method for conveniently buying and selling merchandise (e.g., goods and services) that automatically adjusts a merchandise price based, for example, on a predetermined event.

The present invention includes an inventive system for buying and selling merchandise which includes a network having a plurality of user terminals, a memory device for storing a predetermined event for the merchandise, and at least one processor, accessible by the plurality of user terminals, for automatically adjusting a price of the merchandise based on the predetermined event, and matching buyers with the merchandise to facilitate a transaction.

Specifically, the network may include a central server accessible by the user terminals for storing transaction data. The network may be, for example, the internet allowing the inventive system to be implemented over the World Wide Web. Further, the user terminals may include a processor, a memory device accessible by the processor for storing data, a video display, and an input device. In addition, the processor may include many processors which may be a part of the website or remote from the plurality of user terminals.

In addition, the inventive system may automatically adjust the price of the merchandise when a predetermined event (e.g., a decrease in an expiration period) occurs. For example, the price of time-sensitive merchandise which decreases in quality over time, may be automatically decreased at a predetermined interval, determined by the seller. Further, the inventive system may calculate a quantity of an order to be purchased on a particular date based on a consumption rate for the merchandise so as to minimize a total price for the order.

Further, the system may include a plurality of websites used by the seller to transfer merchandise, for example, from a website for high quality merchandise to a website for low quality merchandise upon the occurrence of a predetermined event (e.g., when an expiration period expires).

Further, the seller may use a user terminal to input selling data and a buyer may use a user terminal to input purchasing data, and wherein said at least one processor matches buyers with merchandise by comparing said selling data and said buying data. In addition, the processor in the inventive system may automatically adjust the price based on a selling rate so as to substantially eliminate a seller's unsold merchandise. Furthermore, the processor may automatically adjust the price of the merchandise based on other factors such as the quality of the merchandise or the destination address (e.g., the buyer's address) for the merchandise.

The present invention also includes an inventive method for buying and selling merchandise (e.g., time-sensitive merchandise) over a network having a plurality of user terminals. The inventive method includes inputting transaction data into the network so that the data is accessible at a user terminal, automatically adjusting the price of the merchandise based on a predetermined event (e.g., a decrease in an expiration period), and matching buyers with the merchandise to facilitate a transaction. The transaction data may include, for example, seller merchandise data and buyer purchasing data.

The inventive method may also include identifying an expiration date for a time-sensitive merchandise, and calculating a quantity of an order to be purchased on a particular date based on a consumption rate for the merchandise so as to minimize a total price for the order. The inventive method may also include other features, such as notifying the buyer and seller when a match is identified and searching the network to find a lowest price for said merchandise. The method may also include sorting merchandise based on corresponding prices of the merchandise; and placing an order for said merchandise having a lowest price.

With its unique and novel features, the inventive system and method allow for the convenient buying and selling of merchandise which benefits seller by ensuring a fair price (e.g., a price timely adjusted for inflation) and by reducing the amount of unsold and wasted merchandise, and benefits the consumer by providing merchandise (e.g., time-sensitive merchandise) at a reduced price.

### BRIEF DESCRIPTION OF THE DRAWINGS

The foregoing, and other objects, aspects, and advantages will be better understood from the following detailed description of a preferred embodiment(s) of the invention with reference to the drawings, in which:

FIG. 1 is a schematic drawing of a conventional system 100 for buying and selling merchandise according to the prior art;

FIG. 2(a) is a schematic drawing of an inventive system 200 for buying and selling merchandise (e.g., time-sensitive merchandise) according the present invention;

FIG. 2(b) illustrates a typical table for displaying merchandise data in the inventive system, according to the present invention;

FIG. 3(a) is a schematic drawing of an inventive system 300 for buying and selling merchandise having a plurality of websites according to the present invention;

FIG. 3(b) is a flow chart illustrating an algorithm 350 used to automatically adjust a price of merchandise according to the present invention;

FIG. 4 is a flow chart illustrating an inventive method 400 for buying and selling merchandise according to the present invention;

FIG. 5 illustrates an exemplary hardware/information handling system 500 for use with the present invention therein; and

FIG. 6 illustrates a signal bearing medium 600 (e.g., storage medium) for storing steps of a program of a method according to the present invention.

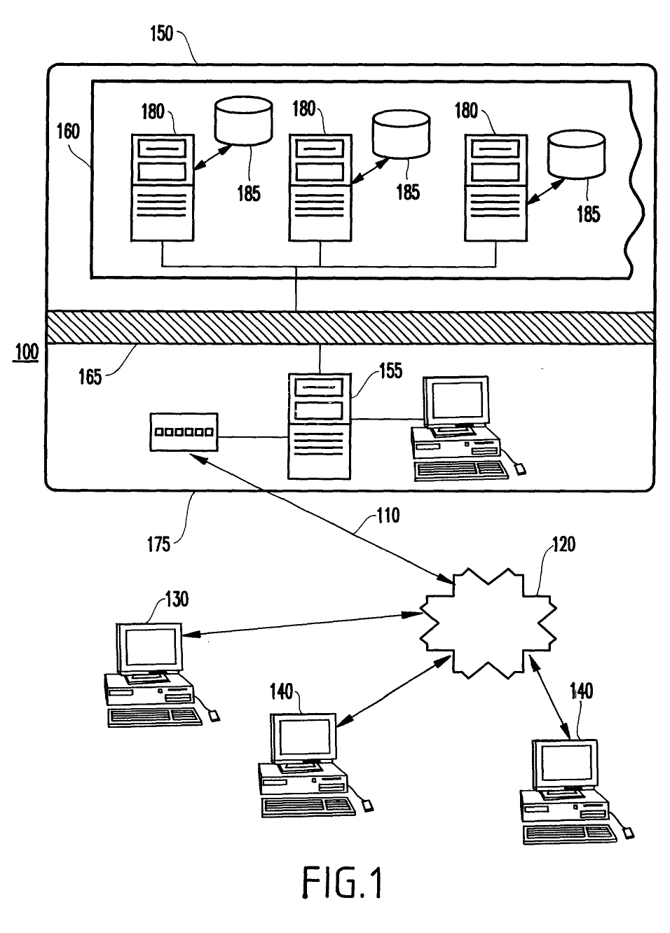

### DETAILED DESCRIPTION OF PREFERRED EMBODIMENTS OF THE INVENTION

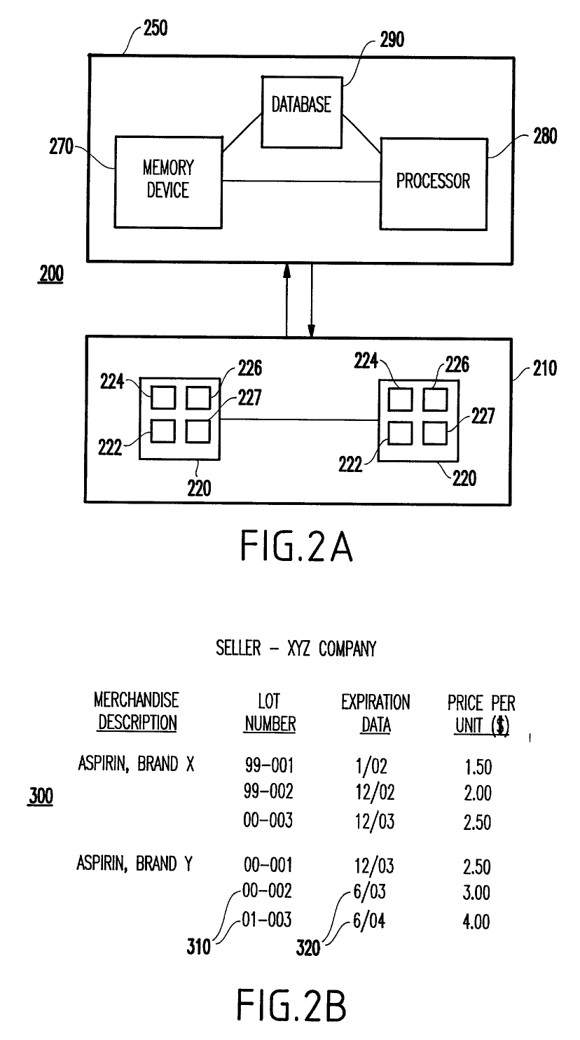

Referring now to the drawings, and more particularly to FIG. 2(a), the present invention includes a system 200 for buying and selling merchandise (e.g., goods and services). As shown in FIG. 2(a), in a preferred embodiment, the inventive system 200 includes a network 210 having a plurality of user terminals 220. The inventive system 200 automatically adjusts the price of merchandise (e.g, time-sensitive merchandise) based on the a predetermined event (e.g., a decrease in an expiration period) and matches buyers and sellers in the network to facilitate a commercial transaction. It is noted that, while the exemplary embodiment is directed to goods, commerce in services (e.g., time-sensitive services) would be equally embraced by the invention. In addition, it should be noted that the present invention may be conveniently used to automatically increase or decrease a price of merchandise, based on a variety of factors.

Specifically, the network 210 in the inventive system 200 may include, for example, an electronic network 210 such as a local area network (LAN), wide area network (WAN) or the internet. In a preferred embodiment, for instance, the inventive system 200 is implemented on the internet utilizing the existing protocols and components of the World Wide Web. In this case, a user terminal 220 may include a desktop computer operating a standard web browser. For example, a buyer may use the web browser on a desktop computer to communicate over the internet with a seller's website using a bi-directional function calling protocol.

For instance, as shown in FIG. 2(a), the user terminals 220 are connected to the internet and utilizing the World Wide Web. Although only 2 user terminals 220 are shown in FIG. 2, it is understood that the network may include many more user terminals. These user terminals 220 may be used by buyers and sellers to buy and sell merchandise over the World Wide Web (WWW). For instance, a buyer may use a user terminal 220 to browse sellers' web sites to search for merchandise and purchase the merchandise at the lowest price.

As shown in FIG. 2(a), the user terminal 220 may include processor 222, a memory device 224, video display 226, and an input device 227 (e.g., a keyboard). The processor 222 may be used to execute a standard web browser such as, for example, Microsoft Internet Explorer® or Netscape Navigator®.

In addition, the inventive system 200 may include a seller website 250 which includes a processor 280, memory device 270 for storing hypertext markup language (HTML) documents (i.e., a collection of data encoded according to the hypertext markup language) and a seller database 290. The processor 280 may be used to execute a standard web server such as Microsoft Internet Information Server®.

For example, a buyer may use the web browser to access a seller's website 250 on the World Wide Web. The web server of the website 250 responds to the access initiated by the buyer by retrieving a first HTML document from the set of HTML documents stored at the seller's website 250, and then transmits the first HTML document to the web browser of the buyer's user terminal 220.

The web browser on the buyer's terminal 220 interprets the HTML document and displays on the video display 226 a representation of the document. The document may, for example, present textual information to the buyer describing the seller's website, such as the nature of merchandise offered for sale and the forms of payment accepted in filling orders for the merchandise. In addition, the HTML document may present options (e.g., hypertext links) which may be selected by the buyer using, for example, the input device 227 to cause the user terminal 220 to transmit requests to the web server to retrieve and transmit additional HTML documents providing related or more detailed information. The buyer may thereby browse additional HTML documents in addition to related hypertext links for additional information.

The inventive system 200 further includes a memory device 270 for storing, inter alia, a predetermined event (passing of a unit period in an expiration period for the merchandise) which causes the system 200 to automatically adjust the merchandise price. The memory device 270 may, for example, be contained within the seller's website 250 and include various information regarding the merchandise. Such information may include, for example, a description of the merchandise, the predetermined event triggering the automatic price adjustment, and the price of the merchandise. Further the website 250 may store (e.g., as an HTML document) a table containing such information and which is therefore, accessible by any user terminal 220 connected to the internet. Such a table may be caused to appear, for instance as the table 300 shown in FIG. 2(b). As shown in FIG. 2(b), the table 300 may list, for example, particular lots 310 of merchandise and the expiration dates 320 of merchandise which may vary from one lot to the next.

In addition, the seller's website 250 may include various hypertext links which allow the buyer to input data which may be processed by the website 250. For instance, using the input device of the user terminal 220, the buyer may input a desired quantity of a particular merchandise and the website 250 may use the input information to generate data tailored to the buyer's particular needs. For example, the buyer may input a consumption rate or a maximum price the buyer is willing to pay for the merchandise and the website may process the information and generate data for the buyer to view on the user terminal 220. Such data may include for example, a quantity of a particular lot of merchandise which the buyer may purchase to minimize the buyers price paid for the merchandise.

In addition, the website 250 may include a database 290 which is accessible by the memory device 270 and the processor 280. The database 290 may be used to store, for example, text images and sound files, in addition to demographic data regarding purchasers (e.g., name, address, company profile), customer identification numbers and electronic signatures. In addition, the database 290 may be used, for example, to store data which is also stored in the memory device 270 as well as other data related to purchasers or to the merchandise, such as the quantity of the merchandise the buyer desires to purchase or the quality of the merchandise. Moreover, the processor 280 may adjust data stored in the memory device 270 based on data accessed by the processor 280 in the database 290.

Further, the price of the merchandise may be automatically adjusted based on data stored in the database 290 or the memory device 270. For example, if a particular lot of produce has a high quality, the price of the merchandise may be adjusted upwardly to reflect the higher quality of the merchandise. For example, the price may thereafter be adjusted periodically as an expiration period of the merchandise gets closer to expiring (i.e. as the expiration date for the merchandise approaches).

The inventive system 200 also includes a processor 280 for processing data. Generally, the processor 280 may perform automatic updates to various information on the webside 250 to automatically change the information contained on the website 250. In addition, the processor 280 may match buyers with a particular merchandise to facilitate a transaction. As shown in FIG. 2(a), the processor 280 should be accessible by the plurality of user terminals and may be implemented, for example by a conventional processor. In a preferred embodiment, for example, the processor 280 may be included in the seller's website 250.

Specifically, the processor 280 automatically adjusts the price of the merchandise sold by the seller. This may be done periodically (e.g., every minute, hour, day, week, etc.). For example, the price of the time-sensitive merchandise may be automatically reduced as an expiration period gets closer to expiring. For example, the seller may input to the website 250 a particular lot of merchandise, the cost to the seller for the merchandise, the units in which the merchandise is sold, an initial price for that particular lot and an expiration period for that particular lot. The seller may input other information such as a rate of decrease in price or a final price to be charged when the expiration period expires. Alternatively, the website 250 may include default figures in the place of such data. For example, if no final price is entered the website 250 may automatically set an final price of $5.00 per unit of merchandise.

Further, the processor 280 may automatically adjust a price of merchandise based on other data such as, for example, the sales rate for the merchandise. For example, processor 280 may monitor a quantity of time-sensitive merchandise remaining to be sold. If, for example, at the existing sales rate there will be a quantity of the merchandise remaining, the processor 280 may automatically adjust the price of the merchandise by a predetermined amount calculated to deplete the inventory by the expiration period. In addition, the predetermined amount may be determined by an algorithm stored in the website 250 and based upon such factors past sales rates and the corresponding prices of the merchandise, inflation, etc.

In addition, the processor 280 processes data so as to match buyers with said merchandise over the network (e.g., the internet) to facilitate a transaction. For example, the processor 280 may compare a request for a specific quantity of a particular merchandise to the information stored in the website database 290. Therefore, when a specified variable such as requested price, quantity, expiration date, or quality of merchandise, matches a particular lot stored in the database 290 of the website 250, the match is indicated by the website 250 and displayed in a HTML document displayed at the buyer's user terminal 220.

In addition, the processor 280 should be accessible by the user terminals 220. It should be noted that the memory device 270, database 290 and processor 280 for processing data and matching buyers with merchandise are not necessarily located at the seller's website 250 but may be remotely located. For example, these features may be located at another website or in a central server which also stores, for example, ancillary data (e.g., past sales rate and pricing data for a particular merchandise).

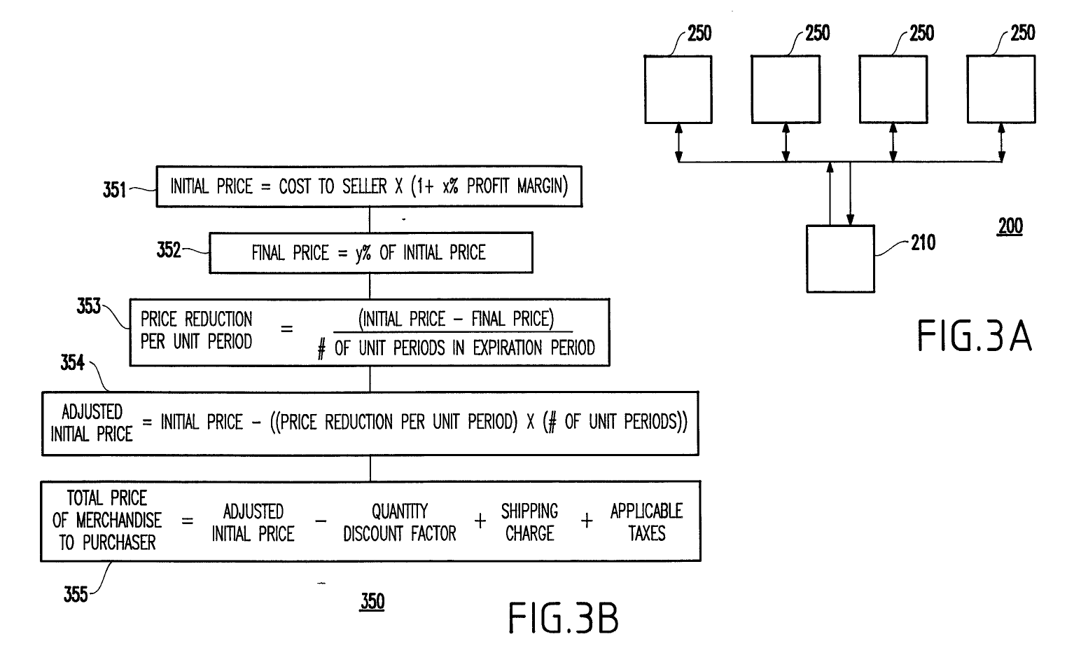

Further, as shown in FIG. 3(a), the inventive system 200 may include a plurality of websites 250 which are communicatively linked to a network 210 such as the internet. In this case, the websites 250 and the network 210 would contain the same features as described above and shown in FIG. 2(a). However, in addition, the inventive system 200 having a plurality of websites 250 would allow a seller to automatically transfer items from one website 250 to another website 250 upon the happening of a certain event (e.g., a predetermined event).

For instance, the system 200 may include a first website 250 which is directed to a first group of consumers having a relatively higher quality standard and a second website 250 directed to a second group of consumers having a relatively lower quality standard. For example, the first group of consumers may have a government which requires high quality standards for medicine so that a sale of a particular medicine is prohibited after a certain date (i.e., the medicine has a short expiration period). However, the second group of consumers having a relatively lower quality standard may have a government which allows the sale of that particular medicine for another year or may even have no controls over the sale of that particular medicine. In that case the seller can transfer the merchandise from the first website to the second website when, for example, an expiration period with respect to the first group of consumers expires. At that point, for example, that particular lot of merchandise may be automatically deleted from the database or memory of the first website and added to the database or memory of the second website.

It should be noted, of course, that the first website may be used for lower quality merchandise and the second website for relatively higher quality merchandise. This arrangement may be helpful, for example, for time-sensitive merchandise (e.g., antiques, baseball trading cards, etc.) that increases in value over time or upon the happening of a particular event (e.g., a predetermined event such as a depletion in supply for that particular merchandise). In this case, when the triggering event occurs (e.g, the merchandise price rising to a predetermined level), the merchandise may be automatically transferred from the lower quality website to the relatively higher quality website.

In addition, the predetermined event may be stored in the database of each website so that this change may be automatically carried out by programs stored in the database of each website. Alternatively, the websites 250 may be programmed to alert the seller that a predetermined event has occurred or is about to occur (e.g., an expiration period is about to expire) so that the seller can decide for himself what website to which the merchandise should be transferred based, for example, on external or time-sensitive parameters which are not stored in the websites' databases.

Further, as shown in FIG. 3(b), the inventive system 200 may include an algorithm 350 (e.g., a predetermined algorithm) which may be stored, for example, in a website database and used to automatically adjust a price of merchandise. As shown in FIG. 3(b), for example, an initial price for a time-sensitive merchandise may be determined (351) by adding a profit margin to the seller's cost. The final price (i.e., the price the seller will demand at the end of an expiration period) may be determined (352) by multiplying the initial price by a predetermined percentage. The periodic price reduction per unit period (e.g. the amount the price is reduced per week, month, quarter, etc) may be determined (353) by dividing the difference between the initial price and final price, by the number of unit periods in the expiration period.

An adjusted initial price may then be determined (354) by multiplying the price reduction per unit period by the number of periods that have expired, and subtracting the resulting figure from the initial price. The adjusted initial price may be, for example, the figure which is displayed on the seller's website 250. In other words, the adjusted initial price is the general price of the time-sensitive merchandise before considering the purchaser's information (e.g, the quantity purchased, shipping cost, and purchaser's location). The total price of the time-sensitive merchandise to the purchaser may then be determined by adjusting the adjusted initial price according to purchaser-specific information. For instance, the total price to the purchaser may be determined (355) by subtracting a quantity discount factor (e.g., # of units ordered multiplied by a percent reduction per unit) adding a shipping charge (e.g., depending upon the amount ordered and the shipping destination) and the applicable taxes. Therefore, once the purchaser has input the information needed to complete the transaction (e.g., the information needed to calculate the purchaser's total price) the seller's website 250 may cause the purchaser's total price to be displayed on the purchaser's display. If the purchaser is satisfied with the total price, he may then enter any other information needed to complete the transaction (e.g., method of purchase, credit card number, preferred shipping time, etc.) at which point the transaction may be complete.

It should be noted, of course, that one of ordinary skill in the art would understand that this particular algorithm 350 is merely exemplary and any number of algorithms may be stored and used by the present invention to automatically adjust a price of merchandise. For example, an algorithm can be used to automatically increase a price of merchandise which increases in value over time or upon the happening of a predetermined event. For instance, an algorithm may be used to automatically increase the price of an antique car by a certain factor periodically (e.g., every year), or to increase the price of a particular baseball card as the quantity of that card on the market decreases.

Further, the inventive system may use an algorithm to automatically adjust a price of merchandise that is not considered time-sensitive. Such merchandise may include, for example, general merchandise such as textiles or hardware (e.g., hammers and nails) that has no expiration period and are not antiques. For example, an algorithm may be used to generally adjust the price of such general merchandise for inflation, or upon a depletion of the merchandise in the market, or based on an increase in the federal reserve discount rate.

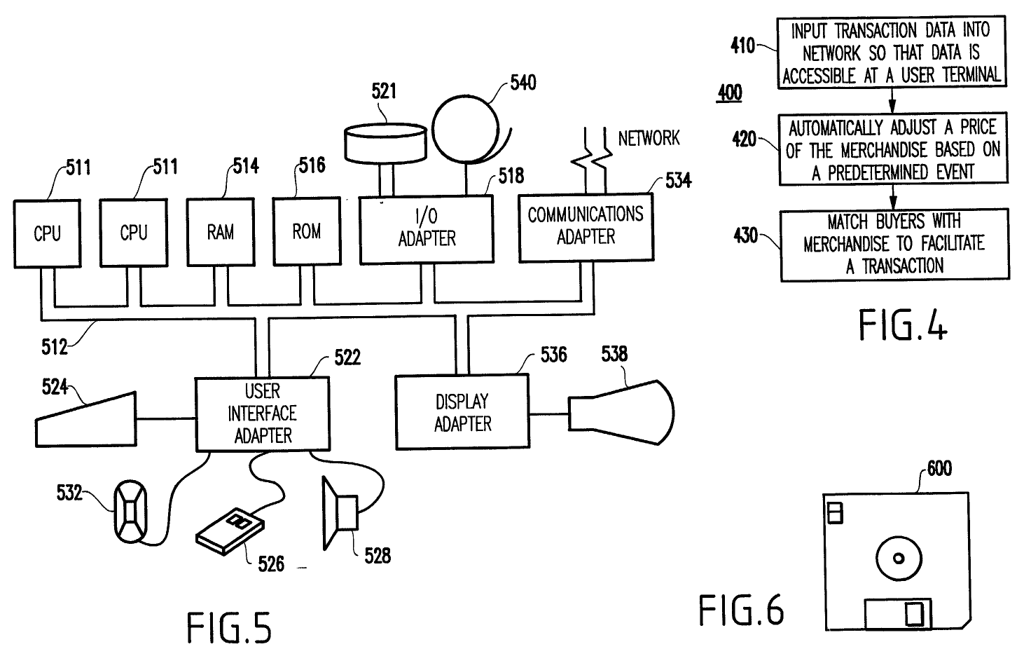

Referring now to FIG. 4, the present invention also includes an inventive method 400 for buying and selling merchandise (e.g, time-sensitive merchandise) over a network having a plurality of user terminals. As shown in FIG. 4, the inventive method 400 includes inputting (410) transaction data into said network so that said data is accessible at a user terminal, automatically adjusting (420) a price of the merchandise based on a predetermined event, and (430) matching buyers with the merchandise to facilitate a transaction.

Specifically, in a preferred embodiment, the inventive method 400 is implemented over the internet. For instance, the seller may input (410) into the website database, information regarding the merchandise, such as lots, expiration periods, qualities, and quantities, country of origin, or manufacturer of the merchandise. Buyers may then browse the seller's website on the World Wide Web using a desktop computer with a standard web browser.

In addition, the seller may use a processor (e.g., one included in the website) to automatically adjust (420) the price of the merchandise based on a predetermined event (e.g., the passing of a unit period such as a week, month, quarter, etc.). As mentioned above, this allows the price of the merchandise to be automatically adjusted, for example, over time or to adjust for inflation. For example, the inventive method 400 may be used to automatically increase a price of merchandise for inflation in short periods. Therefore, unlike conventional methods in which a seller may increase a price every year or two years based on inflation causing purchasers to experience “sticker shock” because of the abrupt increase in price, the inventive method 400 allows a seller to frequently increase prices (e.g, for inflation) in small amounts allowing the seller to subtly increase the price.

For instance, a newly manufactured bottle of aspirin may be priced at $2.00. However, as the 3 year expiration period gets closer to expiring, the price should be reduced to reflect the true value of the aspirin. That is, the quality of the aspirin may not have changed, but it is unlikely that a consumer would purchase a bottle of aspirin having a 6 month expiration period for the same price as a bottle of aspirin having a 3 year expiration period. Unless the consumer has a high demand for aspirin, the consumer may only consume a small portion of the bottle before the expiration period expires. Therefore, the value of the bottle having a short expiration period has less value to the consumer than the new bottle.

The inventive method 400, therefore, may automatically adjust (420) the price of the merchandise, for example, by reducing or increasing the price based on a predetermined event (e.g., the passing of a unit period for time-sensitive merchandise). For instance, as the expiration period for the bottle of aspirin expires, its price may be automatically reduced from an initial price of $2.00 per bottle to a final price (i.e, when the aspirin expires) of $1.00 per bottle. At this point the aspirin may be automatically removed from a first website and added to a second website directed to goods having a lower quality. Such a website may be, for example, directed to consumers in a country with a longer expiration period for aspirin.

Thus, this feature is especially beneficial to a purchaser which can consume large quantities of merchandise in a short period of time. For instance, a hospital quickly consumes large quantities of medicines and other medical related merchandise having an expiration date. A hospital purchasing agent may determine, for instance, that the hospital consumes about 100 bottles of aspirin a month. The purchasing agent may, therefore, use the inventive method 400 to purchase from the seller, 600 bottles of a particular lot of aspirin having a 6 month expiration period at a reduced price (or 300 bottles having a 3 month expiration period or 100 bottles having a one month expiration period, etc.). Thus, considerable savings can be realized by the automatic reduction of the price of the aspirin as the expiration period expires.

Further, the inventive method 400 includes matching (430) buyers with the merchandise to facilitate a transaction. This may be conveniently performed, for example, by a seller's website. For instance, the buyer may input data regarding the quality, price and expiration period of the merchandise desired, and the website may store and process this information to locate a particular brand or lot of the merchandise which matches the buyer's data. For example, a hospital purchasing agent may input to the seller's website a request for 600 bottles of aspirin having a 6 month expiration period. The seller's website can compare this request with the data stored by the website to identify (i.e., match) the merchandise which fits the buyers request.

Further, it should be emphasized that the inventive system and method is not limited to automatically decreasing the price of merchandise (e.g., merchandise that decreases in value over time), but also may be used to automatically increase a price of merchandise, for example, merchandise that increases in value as time goes by. As noted above, such merchandise may include, for example, antiques, baseball trading cards or other such items that are time-sensitive in a way that may cause their value to increase over time. In addition, the inventive system and method may be used for merchandise that is not considered time-sensitive, in which case the merchandise price may be adjusted based on a predetermined event. For example, as quantities (e.g., the number of units of such merchandise on the market, or the number of units in the seller's inventory) are depleted.

Referring now to FIG. 5, system 500 illustrates a typical hardware configuration which may be used for implementing the inventive system and method for buying and selling merchandise. The configuration has preferably at least one processor or central processing unit (CPU) 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, and Intranet, a personal area network (PAN), etc., and a display adapter 536 for connecting the bus 512 to a display device 538 and/or printer 539. Further, an automated reader/scanner 540 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 511 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 511 and hardware above, to perform the method of the invention.

This signal-bearing media may include, for example, a RAM contained within the CPU 411, as represented by the fast-access storage for example. Alternatively, the instructions may be contained in another signal-bearing media, such as a magnetic data storage diskette 600 (FIG. 6), directly or indirectly accessible by the CPU 511.

Whether contained in the computer server/CPU 511, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

With its unique and novel features, the inventive system and method allow for the convenient buying and selling of merchandise which benefit seller by ensuring a fair price for the merchandise (e.g., adjusted for inflation) reducing the amount of unsold and wasted merchandise, and benefits the consumer by providing merchandise at a reduced price.

While the invention has been described in terms of preferred embodiments, those skilled in the art will recognize that the invention can be practiced with modification within the spirit and scope of the appended claims.

What is claimed is:

1. A system for buying and selling merchandise, comprising:
a network comprising a plurality of user terminals;
a memory device for storing a predetermined event for said merchandise; and
at least one processor, accessible by said plurality of user terminals, for automatically adjusting a price of said merchandise based on said predetermined event, and matching buyers with said merchandise to facilitate a transaction.

2. The system according to claim 1, wherein said merchandise comprises time-sensitive merchandise.

3. The system according to claim 2, wherein said predetermined event comprises a decrease of an expiration period.

4. The system according to claim 1, wherein said network comprises a central server accessible by said plurality of user terminals for storing transaction data.

5. The system according to claim 1, wherein each of said user terminals comprises:
a processor;
a memory device accessible by said processor for storing data;
a video display for displaying an image representing said data; and
an input device.

6. The system according to claim 1. wherein said network comprises an internet-based network.

7. The system according to claim 1. wherein said at least one processor is remote from said plurality of user terminals.

8. The system according to claim 1. wherein said at least one processor comprises a plurality of processors.

9. The system according to claim 3 wherein said price is automatically reduced as said expiration period gets closer to expiring.

10. The system according to claim 3. wherein said price is automatically adjusted at a predetermined interval.

11. The system according to claim 3. wherein said system identifies an expiration date for a particular merchandise and calculates a quantity of an order to be purchased on a particular date based on a consumption rate for said merchandise so as to minimize a total price for said order.

12. The system according to claim 1, wherein said processor automatically adjusts said price based on a selling rate so as to substantially eliminate a seller's unsold merchandise.

13. The system according to claim 1, wherein a seller uses a user terminal to input selling data and a buyer uses a user terminal to input purchasing data, and wherein said at least one processor matches buyers with merchandise by comparing said selling data and said buying data.

14. The system according to claim 1, wherein said processor automatically adjusts a price of said merchandise based on a quality of said merchandise.

15. The system according to claim 1, wherein said processor automatically adjusts a price of said merchandise based on a destination address for said merchandise.

16. An system for selling merchandise over a network, comprising:
a plurality of user terminals, each of said user terminals comprising a processor for executing a web browser;
a website accessible by a user terminal; and
a processor, accessible by said website, for executing a web server and for automatically adjusting a price of said merchandise based on a predetermined event.

17. The system according to claim 16, wherein said website comprises a plurality of websites.

18. The system according to claim 17, wherein each website in said plurality of websites is directed to merchandise having a different quality level.

19. A system for buying and selling merchandise, said system having a machine readable recording medium comprising a program for:
pricing said merchandise based on a predetermined event;
inputting transaction data into said network so that said data is accessible at a user terminal; and
matching buyers and sellers of said merchandise in said network to facilitate a transaction.

20. An electronic market system for facilitating commercial transactions, said system comprising:
an electronic network;
a transaction initiating terminal connected to said network for sending and receiving transaction data;
a transaction destination terminal connected to said network for sending and receiving transaction data, and
a processor accessible by said transaction initiating terminal and said transaction destination terminal and comprising software for automatically adjusting a merchandise price based on a predetermined event.

21. An system for conducting electronic commerce, comprising:
a network;
a vendor input device for inputting vendor data to said network;
a buyer input device for inputting buyer data to said network; and
a processor accessible by said vendor input device and said buyer input device for automatically adjusting a price based upon said a predetermined event and comparing said vendor data and said buyer data to allocate merchandise.

22. A system for buying and selling merchandise, comprising:
a network;
at least one server connected to said network for storing data; and
a central processor unit operatively associated with said at least one server for processing said data and automatically adjusting a price of said merchandise based on a predetermined event.

23. A method for buying and selling an item over a network having a plurality of user terminals, said method comprising:
inputting transaction data into said network so that said data is accessible at a user terminal;
automatically adjusting a price of said item based on a predetermined event; and
matching buyers with said item to facilitate a transaction.

24. The method according to claim 23, wherein said transaction data comprises seller item data and buyer purchasing data.

25. The method according to claim 23, wherein said network comprises a central server accessible by said plurality of user terminals for storing transaction data.

26. The method according to claim 23, wherein said network comprises an Internet-based network.

27. The method according to claim 23, wherein said transaction data is stored remote from said plurality of user terminals.

28. The method according to claim 23, wherein said item comprises a time-sensitive item having an expiration period and wherein said price is automatically reduced as said expiration period gets closer to expiring.

29. The method according to claim 28, wherein said price is automatically adjusted at a predetermined interval as said expiration period approaches.

30. The method according to claim 28, further comprising:
identifying an expiration date for a particular item; and
calculating a quantity of an order to be purchased on a particular date based on a consumption rate for said item so as to minimize a total price for said order.

31. The method according to claim 23, wherein said price is automatically adjusted based on a selling rate so as to substantially eliminate a seller's unsold item.

32. The method according to claim 23, wherein a seller uses a user terminal to input selling data and a buyer uses a user terminal to input purchasing data, and wherein buyers are matched with items by comparing said selling data and said buying data.

33. The method according to claim 23, wherein a price is automatically adjusted based on a quality of said item.

34. The method according to claim 23, wherein a price is automatically adjusted based on a destination address for said item.

35. The method according to claim 23, further comprising:
notifying said buyer and said seller when a match is identified.

36. The method according to claim 23, further comprising:
searching said network to find a lowest price for said item.

37. The method according to claim 23, further comprising:
sorting items based on corresponding prices of said items; and
placing an order for said items having a lowest price.

38. The method according to claim 23, wherein said item includes at least one of a good and a service.

39. A method for buying and selling merchandise comprising:
initially pricing said merchandise;
automatically adjusting a price of said merchandise upon the occurrence of a predetermined event; and
matching buyers and sellers of said merchandise to facilitate a transaction.

40. A method of buying and selling merchandise comprising:
inputting pricing and predetermined event data for said merchandise; inputting purchasing data; and
allocating said merchandise based on said purchasing data, said predetermined event data and said purchasing data.

41. A method for buying and selling time-sensitive merchandise comprising:
using the Internet to solicit an order for said merchandise;
accessing a server to search prices and expiration periods of said merchandise corresponding to sellers of said merchandise; and
comparing said prices and said expiration periods to find a seller corresponding to a desired price and expiration period for said merchandise.

42. The system according to claim 3, wherein said price is automatically reduced as time approaches said expiration period.

43. A programmable storage medium tangibly embodying a program of machine-readable instructions executable by a digital processing apparatus to perform a method for buying and selling merchandise, said method comprising:
initially pricing said merchandise;
automatically adjusting a price of said merchandise upon the occurrence of a predetermined event; and
matching buyers and sellers of said merchandise to facilitate a transaction.
